(19) United States
(12) Patent Application Publication
(10) Pub. No.: US 2009/0013571 A1
(43) Pub. Date: Jan. 15, 2009

(54) Vehicle-mounted windsock

(76) Inventor: Gregory Bruce Edmonds, Overland Park, KS (US)

Correspondence Address: Gregory Bruce Edmonds, 7518 Hadley, Overland Park, KS, 66204, US

(21) Appl. No.: 12/217,591

(22) Filed: Jul. 7, 2008

Related U.S. Application Data
(60) Provisional application No. 60/948,551, filed on Jul. 9, 2007.

(51) Int. Cl. G09F 21/04

(52) U.S. Cl. 40/564

(57) ABSTRACT

A machine for mobile display and illumination of team or group logos, mascot images, colors, or other team or group information with a graphics attachment ring that can be opened for graphics removal or closed for graphics capture, an aerodynamically shaped illuminator, an illuminator with side-emitting light distribution optics, an integral control section, a single-action locking stem-to-base stem capture module, a push-to-release stem capture module, an integral battery compartment, an integral circuit board with LED's and microprocessor, individualized or group remote control capabilities, made of plastic, and/or made of metal. A preferred embodiment includes an illuminator that will cause the attached graphics to be illuminated, decorative styling markings, and aerodynamically shaped aesthetics. A preferred embodiment includes a dual or multi-action stem-capture module and integral power generation for use in illuminating graphics

### CROSS REFERENCE TO RELATED APPLICATIONS

This is a continuation of Ser. No. 60/948,551, filed on Jul. 9, 2007, and is also based on provisional application Ser. No. 60/948,551, filed on Jul. 9, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sports and more specifically to a machine for displaying and illuminating team or group logos, mascot images, colors, or other team graphics or group information.

On Aug. 6, 2006, I started sketches on modifications to existing car-mounted flags & windsocks used to display graphics while the vehicle was in motion. My sketches incorporated a light source that would be used to backlight the displayed graphics. Existing units on the market are not illuminated and, therefore, not visible at night. Initial shapes were that of a “hockey-puck” illuminator mounted on a stem with the windsock surrounding the puck. It was very utilitarian, evolving to the more aerodynamically shaped version targeted in this patent application.

The first filed patent, U.S. Pat. No. 3,305,961, relative to my application was filed on Mar. 23, 1966 by AmLeto P. Lanzon and Leo F. Lanzon. It was titled “Portable Illuminated Signal Flag. It detailed a hood-mounted signal panel with an internal lamp. The unit used cord & plug that ran along the car exterior, into the car, and plugged into the car lighter. Successively filed patents were U.S. Pat. No. 4,002,138, filed on Jan. 11, 1977, titled “Auto Safety Flag and Holder”, and Design Patent #368,866, filed on Apr. 16, 1996, titled “Lighted Wind Sock”. The Auto Safety Flag and Holder Patent detailed a non-illuminated, car-window mounted safety flag for warning approaching motorists that the vehicle was disabled. Design Patent #368,866 detailed a Lighted Wind Sock. The patent does not address any aspect of the mounting base or it's method for lighting the windsock. The windsock shows a picture of Rudolph The Red Nosed Reindeer on it.

Earlier versions of car-mounted windsocks and flags did not incorporate batteries since the sources were too large. As with patent U.S. Pat. No. 3,305,961, the housing around the lamp had to be large in order to house the lamp. Advancements in lighting technology, specifically, the introduction and increased use of LED's and smaller battery sizes have allowed light to be incorporated into the car-mounted windsocks and flags as is presented in my patent application. My invention incorporates LED's as the light source behind the side-emitting illuminator, which illuminates the graphics. My invention also incorporates an aerodynamically “stylized” aspect not currently available with the car- mounted flags & windsocks devices on the market.

### BRIEF SUMMARY OF THE INVENTION

The primary object of the invention is to provide an illuminated apparatus for mobile display of team logos and graphics.

Another object of the invention is to provide a vehicle-mounted, aerodynamic, apparatus for mobile display of team logos and graphics.

A further object of the invention is to provide a multi-purpose apparatus that can be re-mounted on different modes of transportation using similar mounting modules or bases.

Yet another object of the invention is to provide a mobile display apparatus that can be remotely controlled, either individually or in groups.

Yet another object of the invention is to provide a decorative and styled apparatus for displaying team logos and graphics.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for displaying and illuminating team or group logos, mascot images, colors, or other team or group graphics comprising: a graphics attachment ring that can be opened for graphics removal or closed for graphics capture, an aerodynamically shaped illuminator, a multi-layer illuminator with side-emitting light distribution optics, an integral control section, a locking stem-to-base stem capture module, a single-action push-to-release stem capture module, an integral battery compartment, an on-board printed circuit board with LED's and microprocessor, individualized or group remote control capabilities, made of plastic, and/or made of metal.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a transparent side elevation view of the invention illustrating the windsock extended and the unit mounted to a window.

FIG. 2 is a front elevation view of the invention.

FIG. 3 is an enlarged view of the LED and lens assembly-housing interface and attachment point.

FIG. 4 is a cross-sectional view cut horizontally down the middle of the lens assembly.

FIG. 5 is a cross-sectional view cut vertically through the illuminator lens assembly.

FIG. 6 is an enlarged elevation view of the housing-to-lens connection point with the printed circuit board and battery compartment door exposed.

FIG. 7 is an enlarged end view of the illuminator lens assembly.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

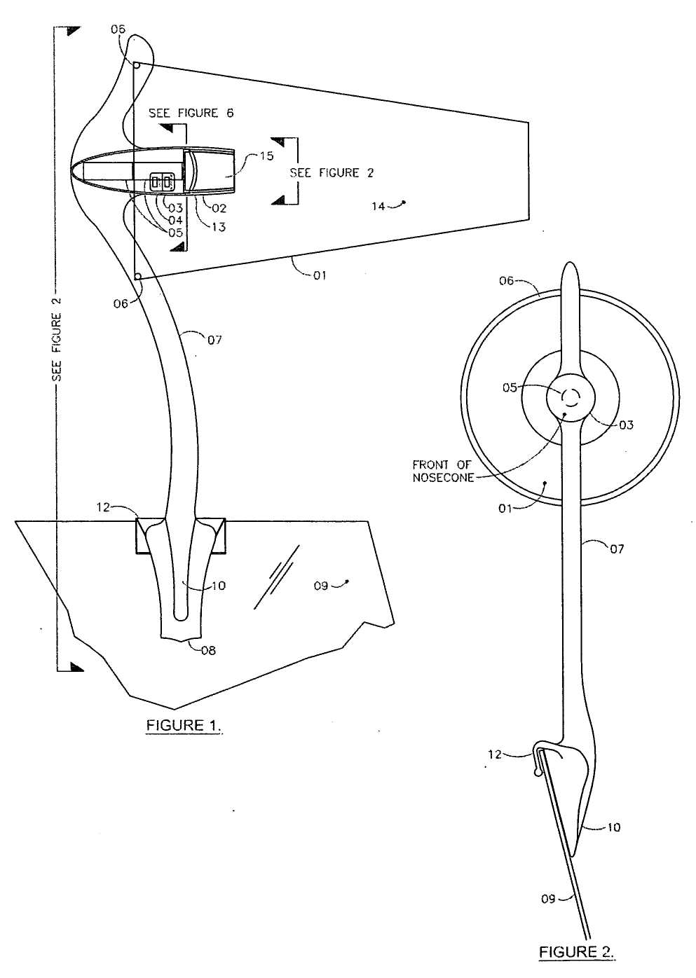

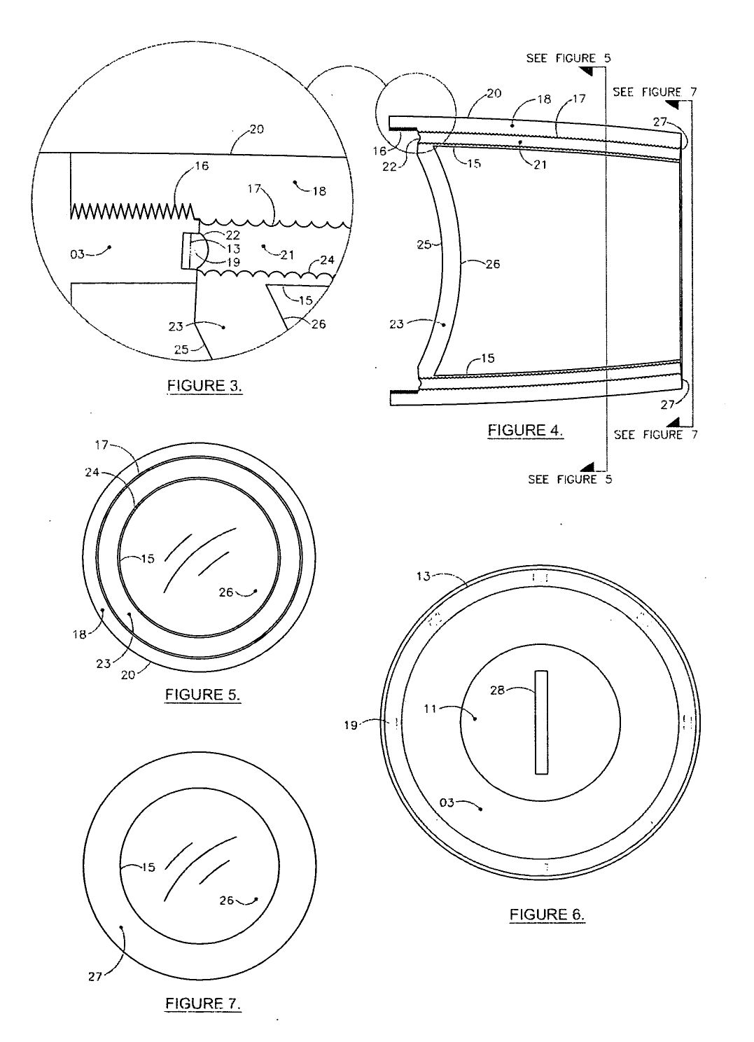

FIG. 1 shows an apparatus for a vehicle-mounted, illuminated, mobile graphics display unit. A weather resistant material 01 forms a surface for the graphics display 14. The graphics material can be nylon, polyester, or another suitable material. The graphic surface 14 is backlit by a centrally-located illuminator lens assembly 02, see FIG. 2, that acts as a directional light source uniformly focusing light on the inside face of the graphic surface 14. The illuminator 02 is comprised of several parts. FIG. 3 shows the intersection where the main housing 03 uses a threaded, weather-tight, connection 16 to attach to the outer layer 18 of the lens assembly 02. The lens assembly 02 is comprised of three adjacent layers, 18, 21, and 23. The outer layer 18 is a clear, hard, weather & UV resistant material that will allow 100% light transmission with approximately 10% diffusion occurring at the outer lens face 20 while the majority of the light diffusion occurs at the intersection of the outer & middle layers 17, where light diffusion grooves 24 are placed. The light diffusion grooves 24 are molded into the lens around the entire perimeter of the lens assembly 02. The light rays generated by the LED's 19 hit the rounded surface of the grooves 17 which further diffuses the light rays spreading out and redirecting the light. The middle layer 21 of the lens assembly is a hard, weather & UV resistant material with approximately 30% opacity. This layer 21 has a groove 22 formed into it's perimeter where the LED lamps 19 and the printed circuit board 13 reside. Each LED 19 will project it's light outward into the middle lens layer 21 where the light will be mixed and overlapped with the light from the other LED's 19 that are located around the perimeter, see FIG. 6. The inner-most layer 23 of the lens assembly 02 is comprised of a hard, weather & UV resistant material that is chrome-like with it's surface and will reflect 100% of all light rays hitting it. Where this inner layer 23 meets the middle layer 21 there is a grooved surface 24 that is molded into both the middle layer 21 and the inner layer 23. These grooves 24 are molded around the entire perimeter of both layers. The non-viewable side 25 of the inner layer 23 will not have a chrome-like finish. The lens assembly 02 is hollow in the center area similar to an open cylinder, see FIGS. 3 & 4, but the finish on the visible surfaces 15, 26, and 27 is chrome-like for aesthetics. The LED's 19 will not be viewable during operation and only viewable when the lens assembly 02 is removed, see FIG. 6. FIG. 7 shows the view while looking at the lens assembly 02 from behind. FIG. 6 shows the main housing 03 with the lens assembly 02 removed. The printed circuit board 13, the LED's 19 mounted on the printed circuit board 13, the battery compartment access door 11, and the main housing 03 are exposed when the lens assembly 02 is removed. The (2) AA batteries 05 are accessed by unscrewing the battery compartment access door 11 using the flat-head screwdriver notch 28 and turning it in a counter-clockwise rotation. The battery compartment access door 11 is made of a non-metallic material, but will have a conductive, metallic contact 10 mounted on the battery-side of the access door 11 that will complete the power circuit when the battery compartment access door 11 is tightened, clockwise, into it's normal operating position. The cylindrically-shaped battery compartment 29 is located in the center of the main housing 03 and houses the batteries 05. It has metallic, conductive contacts 30 and 10 that complete the power circuit needed to power the LED's 19. The device controls 04 consist of a 2-button, dome-style, weather-proof assembly 04 that is adhesive-mounted to the main housing 03 in a recessed depression. The wiring harness from the controls 04 feeds into the main housing 03 through an opening made in the recessed depression. The control sequence operates as follows: Button #1 will be an ON/OFF switch that will turn ON to the last mode of operation. Button #2, if pushed momentarily while unit is ON, will change the colors displayed by the LED's each time it is pushed until each available color in the color cycle has been displayed and then it will start over. If button #2 is pushed and held the unit will be placed in a slow-strobe mode where it will automatically cycle through all available colors continually until the unit is turned OFF or the button #2 is momentarily pushed.

FIG. 1 & FIG. 2 shows the main housing 03 which attaches is molded into the stem 07. The stem 07 also has two circular openings where the windsock attachment ring 06 passes through it. The windsock attachment ring 06 has a mechanical connection that can be opened to allow the windsock 01 to be removed. The windsock stem 07 is mounted to the vehicle by insertion into a window-mounted base 08. The base 08 is clipped to the window 09 by use of a window clip 12 that hooks over the top of the window 09 and is secured when the window 09 is rolled up. The stem 07 and windsock 01 can be removed from the base 08 while the base 08 remains attached to the window 09. The stem to base connection is male-female arrangement.

What is claimed is:

1. A machine for displaying and illuminating team or group logos, mascot images, colors, or other team or group information comprising:
a graphics attachment ring that can be opened for graphics removal or closed for graphics capture;
an aerodynamically shaped illuminator;
a multi-layer illuminator with side-emitting light distribution optics;
an integral control section;
a locking stem-to-base stem capture module;
a single-action push-to-release stem capture module;
an integral battery compartment;
an on-board printed circuit board with LED's and microprocessor;
individualized or group remote control capabilities;
made of plastic; and
made of metal.

2. A machine for displaying and illuminating team or group logos, mascots, colors, or other team or group information as claimed in claim 1 further comprising:
an illuminator that will cause the attached graphics to be illuminated
decorative styling markings
aerodynamically shaped aesthetics

3. A machine for displaying and illuminating team or group logos, mascots, colors, or other team or group information as claimed in claim 2 further comprising
a dual or multi-action stem-capture module
integral power generation for use in illuminating graphics
